(19) United States
(12) Patent Application Publication
(10) Pub. No.: US 2004/0068453 A1
(43) Pub. Date: Apr. 8, 2004

(54) System and method for an analyzing patent indicators

(76) Inventors: XiuMing Duan, Shenzhen (CN); Caiyang Luo, Shenzhen (CN); Gaopeng Hu, Shenzhen (CN); Chung-I Lee, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/335,291

(22) Filed: Dec. 30, 2002

(30) Foreign Application Priority Data
Oct. 4, 2002 (TW) 91122976

(51) Int. Cl. G06F 17/60

(52) U.S. Cl. 705/35

(57) ABSTRACT

A system for analyzing patent indicators includes a local database (150), a plurality of client computers (10), and an application server (12). The local database stores a plurality of company names. The client computers each include an interactive user interface (100) enabling a user to select a set of company names and a patent indicator. The application server includes: a patent-downloading unit (120) for automatically downloading patents of companies in a selected company name set from at least one remote database (160) through a network (14), and for storing the patents in the local database; and a patent indicator analyzing unit (122) including a plurality of patent indicator computing devices (1220) for calculating values of patent indicators, each patent indicator computing device relating to a designated patent indicator and having at least one parameter related to the patent indicator set in advance.

### BACKGROUND OF THE INVENTION

1. Field of the Invention

The present invention relates to a patent analyzing system and method, and particularly to a system and method for calculating values of patent indicators.

2. Background of the Invention

Standards for quantifying real value of intangible assets are intended to facilitate activities such as valuation, transfer and licensing of such intangible assets, including patents. Various quantification standards have been promulgated, such as CHI patent indicators put forward by CHI Research, Inc. of the U.S.A. However, present-day patent indicators are mostly used for valuing all patents of a particular company, or for valuing a particular company's patents in a particular technological field. In the case of giant corporate conglomerates or groups of companies, it is not easy to obtain accurate values of patent indicators due to these companies' often vast portfolios of patents and related inventors. A method for computing values of patent indicators is provided at the website of CHI Research, Inc. However, a user can only obtain a final result by applying the method. The user does not know whether the scope of data used in obtaining the result is appropriate. This is especially the case when the user wants to know patent indicator values for a large group of related companies.

U.S. Pat. No. 6,175,824, entitled Method And Apparatus For Choosing A Stock Portfolio, Based On Patent Indicators and issued on Sep. 25, 2001, discloses a method for using patent indicators to choose a stock portfolio. However, the disclosed method does not deal with how to obtain patent indicator values.

There is a need for users to be able to obtain accurate patent indicator values. Thus, a system and a method are needed for analyzing patent indicators, whereby users can know exactly the scope of relevant information used and thus obtain accurate values of the patent indicators.

### SUMMARY OF THE INVENTION

Accordingly, a main objective of the present invention is to provide a patent indicator analyzing system and method, through which users can obtain accurate values of patent indicators.

To accomplish the above object, a system for analyzing patent indicators in accordance with a preferred embodiment of the present invention comprises a local database, a plurality of client computers and an application server. The local database stores a plurality of company names. The client computers each include an interactive user interface enabling a user to select a set of company names and a patent indicator. The application server comprises a patent-downloading unit and a patent indicator analyzing unit. The patent-downloading unit is for automatically downloading patents of companies in a selected company name set from at least one remote database through a network, and for storing the patents in the local database. The patent indicator analyzing unit includes a plurality of patent indicator computing devices for calculating values of patent indicators. Each patent indicator computing device relates to a designated patent indicator, and has at least one parameter related to the patent indicator set in advance.

Further, the present invention provides a method for analyzing patent indicators, the method comprising the steps of: inputting a company name through a user interface; reading a set of company names related to the company from a local database; selecting at least one company name from the company name set; downloading automatically all patents of the at least one selected company from a remote database; selecting a patent indicator to be analyzed; obtaining a value of the parameter related to the patent indicator by analyzing the downloaded patents; and calculating the patent indicator according to the obtained parameter value.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a diagram showing hardware configuration of a patent indicator analyzing system in accordance with a preferred embodiment of the present invention, including a plurality of client computers;

FIG. 2 is a block diagram showing main function units of the patent indicator analyzing system of FIG. 1, but showing only one of the client computers of FIG. 1; and

FIG. 3 is a flowchart of a preferred method for implementing the patent indicator analyzing system of the present invention.

### DETAILED DESCRIPTION OF THE INVENTION

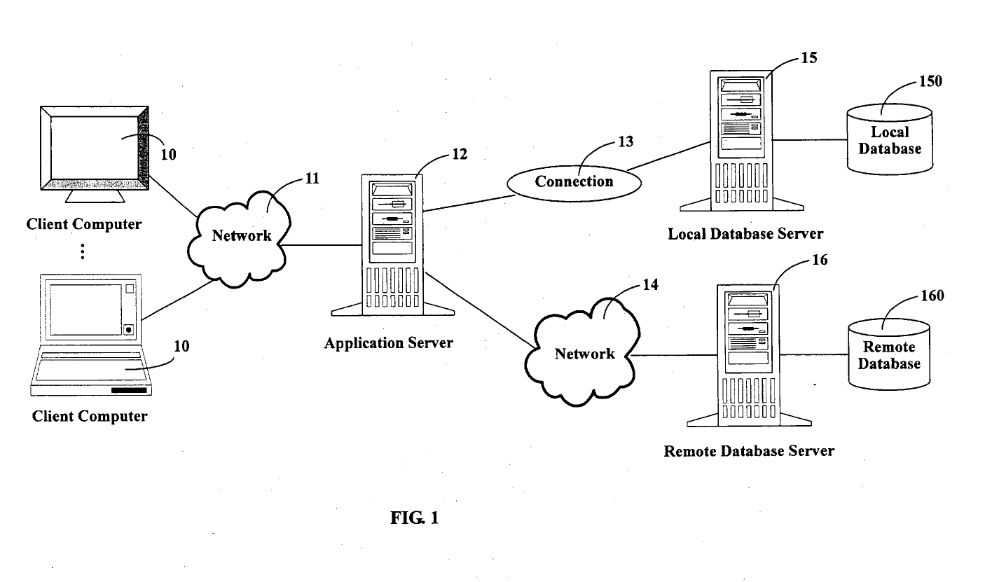

FIG. 1 is a diagram showing hardware configuration of a patent indicator analyzing system in accordance with a preferred embodiment of the present invention. The system includes: an application server 12, a local database server 15, at least one remote database server 16, and a plurality of client computers 10 connected to the application server 12 through a network 11. The application server 12 is connected to the local database server 15 through a connection 13, using connectivity such as ODBC (Open Database Connectivity) or JDBC (Java Database Connectivity). The remote database server 16 is connected to the application server 12 via a network 14, which is an external network such as the Internet. The local database server 15 and the remote database server 16 comprise a local database 150 and a remote database 160 respectively. The application server 12 accesses the information in the local database 150 via the local database server 15, and accesses information in the remote database 160 via the remote database server 16.

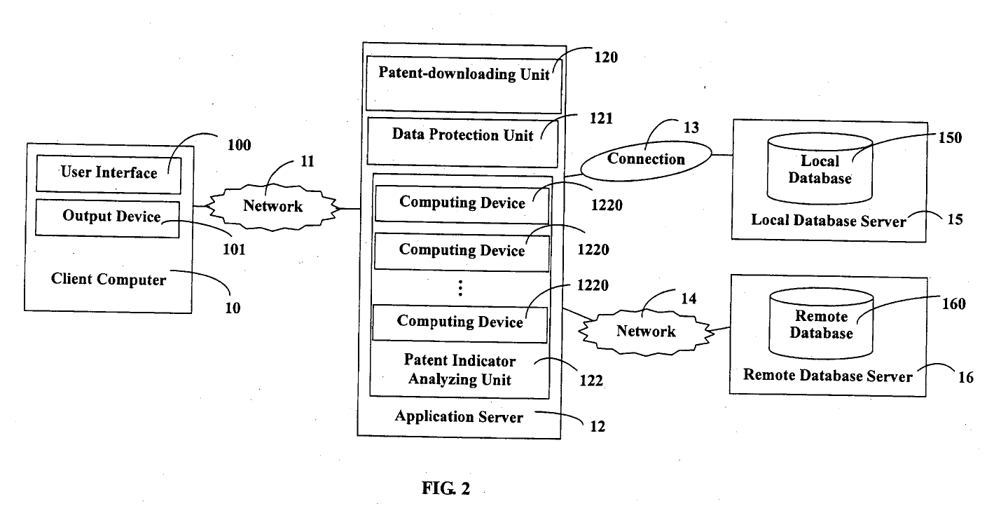

FIG. 2 is a block diagram showing main function units of the patent indicator analyzing system of FIG. 1, but showing only one of the client computers 10 of FIG. 1. The client computer 10 comprises a user interface 100 and an output device 101. The user interface 100 is an interactive interface for a user to implement corresponding operations such as data protection and choice of patent indicators. The output device 101 is used for displaying results of analysis of the patent indicators in the form of words, diagrams or tables. The local database 150 stores at least one set of company names. Each set of company names comprises names of all companies that belong to a same corporate group.

The application server 12 comprises a patent-downloading unit 120, a data protection unit 121 and a patent indicator analyzing unit 122. The patent-downloading unit 120 downloads patents automatically from any remote database 160 such as the database of the United States Patent and Trademark Office. After the user sets downloading qualifications for the patents to be downloaded through the user interface 100, the patent-downloading unit 120 applies for searching of and accessing the relevant patents in the remote database server 16 via the network 14, and stores the patents in the local database 150. The data protection unit 121 enables the user to search, add, modify or delete company names in a company name set.

The patent indicator analyzing unit 122 is used for calculating values of the patent indicators. A plurality of patent indicators are supplied in the preferred embodiment, including Number of Patents, Patent Growth Percent in Technological Area, Percent of Company Patents in Technological Area, Citations Per Patent, Technology Cycle Time (TCT), Science Linkage (SL) and Science Strength (SS). The indicators are explained as follows:

Number of Patents—A count of a company's patents issued in a particular patent office.

Patent Growth Percent in Technological Area—A change in the number of patents from one time period to another, expressed as a percentage.

Percent of Company Patents in Technological Area—A count of a company's patents in a technology area divided by a total number of patents for that company, expressed as a percentage.

Citations Per Patent—A count of citations of a company's patents in all subsequently issued patents.

Technology Cycle Time (TCT)—Indicates a speed of technological innovation. That is, how fast a technology area is “turning over.” This is defined as the median age in years of patent references cited on the front page of a company's patents in a particular patent jurisdiction; for example, in the U.S.

Science Linkage (SL)—An average number of scientific references cited on the front page of a company's patents.

Science Strength (SS)—A number of patents multiplied by science linkage.

The patent indicators and the parameters are listed as follows:

| Patent indicator | Parameter |
|---|---|
| Number of Patents (=n) | n: Number of patents for a company |
| Patent Growth Percent in | nₜ: Number of patents for a company |
| Technological Area | at time t |
| (=(nₜ₊₁ − nₜ)/nₜ* 100%) | |
| Percent of Company | n: Number of patents in a technology |
| Patents in | area; |
| Technological Area | n_{c}: Total number of patents for a |
| (=n_{c}/n* 100%) | company |
| Citations Per Patent (=c) | c: A count of citations of a company's |
| | patents in all subsequent patents |
| Technology Cycle Time (=tₐ/n) | n: Number of patents for a company |
| | tₐ: Years of patent references cited on |
| | the front page of a company's patents |
| Science Linkage (=m/n) | n: Number of patents for a company |
| | m: Number of scientific references |
| | cited on the front page of a company's |
| | patents |
| Science Strength (=m) | m: Number of scientific references |
| | cited on the front page of a company's |
| | patents |

A plurality of patent indicator computing devices 1220 are provided in the patent indicator analyzing unit 122, according to the above-described patent indicators. Each patent indicator computing device 1220 is set in advance with at least one changeable parameter related to the value of the patent indicator.

When the user chooses a patent indicator through the user interface 100, the patent indicator analyzing unit 122 starts the corresponding patent indicator computing device 1220, a search query is created according to the parameter set in advance in the patent indicator computing device 1220, and the search query is transmitted to the local database server 15. The local database server 15 searches the local database 150 for relevant patents, and returns results of the search to the patent indicator computing device 1220. If the search is successful, the result is a value of the parameter; otherwise, the result appears as a false message. After obtaining the parameter value, the patent indicator computing device 1220 calculates a value of the patent indicator according to the obtained parameter value. The patent indicator analyzing unit 122 then transmits the value of the patent indicator to the client computer 10 through the network 11, where the value of the patent indicator is displayed via the output device 101.

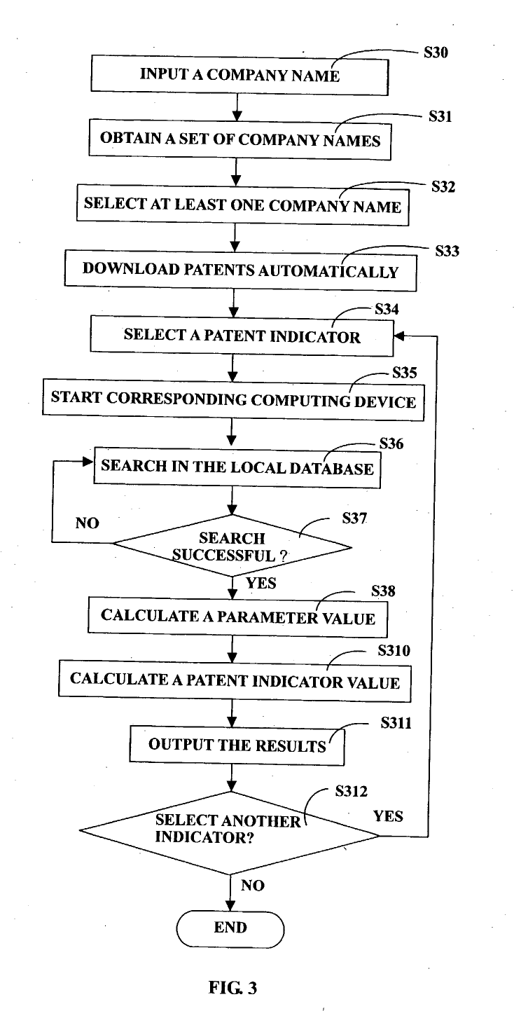

FIG. 3 is a flowchart of a preferred method for implementing the patent indicator analyzing system of the present invention.

In step S30, the user inputs a company name through the user interface 100.

In step S31, the company name is transmitted to the patent-downloading unit 120 through the network 11. The patent-downloading unit 120 searches the local database 150 for information about the company via the local database server 15, and obtains a set of company names that includes the company name.

In step S32, the company name set is transferred to the client computer 10, and the user selects at least one company name from the company name set.

In step S33, the selected company name is transferred to the patent-downloading unit 120 through the network 11, and a search instruction is created. The instruction is then transmitted to the remote database server 16 via the network 14, and all patents of the selected company in the remote database 160 are automatically downloaded. Thereupon, the patents are transferred to the patent-downloading unit 120 and stored in the local database 150 via the connection 13.

In step S34, the user selects a patent indicator through the user interface 100.

In step S35, the patent indicator is transmitted to the patent indicator analyzing unit 122 via the network 11, and the corresponding patent indicator computing device 1220 is started.

In step S36, a search query is created according to the parameter of the patent indicator computing device 1220, the search query is transferred to the local database server 15, and the search instruction is executed in the local database 150.

In step S37, the patent indicator analyzing system determines whether the search is successful.

If the search is successful, in step S38, a parameter value that is calculated as a result of the search is transmitted to the patent indicator computing device 1220.

If the search is unsuccessful, a false message is returned to the local database server 15, and the procedure returns to step S36.

In step S310, the patent indicator computing device 1220 calculates a value of the patent indicator according to the obtained parameter value.

In step S311, the value of the patent indicator is transferred to the client computer 10, and displayed to the user in the form of words, diagrams or tables through the output device 101.

In step S312, the user determines whether more patent indicators need to be analyzed. If more patent indicators need to be analyzed, the procedure returns to step S34. Otherwise, the procedure is ended.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for analyzing patent indicators, the system comprising:
a local database storing a plurality of company names;
a plurality of client computers, each of the client computers including an interactive user interface enabling a user to select a set of company names and a patent indicator; and
an application server comprising:
a patent-downloading unit for automatically downloading patents of companies in a selected company name set from at least one remote database through a network, and for storing the patents in the local database; and
a patent indicator analyzing unit including a plurality of patent indicator computing devices for calculating values of patent indicators, each of the patent indicator computing devices relating to a designated patent indicator and having at least one parameter related to the patent indicator set in advance.

2. The system according to claim 1, further comprising a data protection unit enabling the user to search, add, modify or delete company names in the company name set.

3. The system according to claim 1, wherein the company name set comprises names of all companies that belong to a same corporate group.

4. The system according to claim 1, wherein the at least one remote database comprises any one or more of government patent office databases of various patent jurisdictions.

5. The system according to claim 1, wherein a value of the at least one parameter is obtained by analyzing the patents stored in the local database.

6. The system according to claim 5, wherein each of the patent indicator computing devices calculates a patent indicator value according to the obtained value of the at least one parameter.

7. The system according to claim 1, wherein the client computers each include an output device for displaying values of patent indicators.

8. A method for analyzing patent indicators, the method comprising the steps of:
inputting a company name through a user interface;
reading a set of company names related to the company from a local database;
selecting at least one company name from the company name set;
downloading automatically all patents of the at least one selected company from a remote database;
selecting a patent indicator to be analyzed;
obtaining a value of a parameter related to the patent indicator by analyzing the downloaded patents; and
calculating the patent indicator according to the obtained parameter value.

9. The method according to claim 8, further comprising the step of displaying a value of the calculated patent indicator to the user.

10. The method according to claim 8, further comprising any one or more of the steps of searching, adding, modifying and deleting a company name in the set of company names.

11. A method of analyzing patent indicators, comprising steps of:
(1) inputting a company name;
(2) downloading all patents automatically from a remote database to a local database under said company name;
(3) setting a plurality of patent indicators to be analyzed;
(4) starting a corresponding computing device;
(5) searching in the local database and obtaining a value of parameter related to one of said indicators by analyzing the downloaded patents;
(6) calculating a patent indicator value according to the obtained parameter value; and
(7) repeating steps (4)-(6) for another patent indicator until all patent indicators are used up.
